(19) United States
(12) Patent Application Publication
(10) Pub. No.: US 2017/0020341 A1
(43) Pub. Date: Jan. 26, 2017

(54) MULTI-FUNCTION KITCHEN UTENSIL

(71) Applicant: Duane Farmer, Bolivar, MO (US)

(72) Inventor: Duane Farmer, Bolivar, MO (US)

(21) Appl. No.: 15/214,802

(22) Filed: Jul. 20, 2016

Related U.S. Application Data
(60) Provisional application No. 62/194,542, filed on Jul. 20, 2015.

(51) Int. Cl. A47J 43/24; A47J 43/22; A47J 47/00

(52) U.S. Cl. CPC A47J 43/24; A47J 47/005; A47J 43/22

(57) ABSTRACT

A multi-functional bowl with an integrated strainer and funnel, where the bottom of the bowl is rigid and can be used as a cutting board. The bowl is provided with measuring gradient markings and pouring spouts along the sides. The bowl is microwave and dishwasher safe.

### CROSS-REFERENCE TO RELATED APPLICATION

This application claims the priority of U.S. Provisional Patent Application No. 62/194,542 filed Jul. 20, 2015, which is incorporated by reference herein in its entirety.

### FIELD OF INVENTION

The present invention relates to a kitchen utensil having multiple features and functions. More particularly, it is a multi-function bowl having an integrated strainer, funnel, measuring gradients and cutting board. The bowl is constructed of materials that are microwave and dishwasher safe.

### RELATED ART

Various kitchen utensils are known which perform more than a single function. For example, some bowls have measuring lines. A cutting board might have an integrated funnel assembly, such as the one disclosed in U.S. Pat. No. 6,371,470 to Ward. Cutting boards also exist with strainers or colanders, U.S. Pat. No. D557,085 to Shamoon. A bowl could have some form of associated cutting board, such as that disclosed in U.S. Pat. No. 5,423,451 to Snyder.

While various combination kitchen utensils are known, there are no known multi-functional bowls which include a funnel, a strainer, a cutting board and measuring lines. Applicant's invention combines all of these functions and more. Further, the bowl will include at least one spout formed within the upper periphery of the vessel. Many multi-use kitchen appliances have removable parts, are difficult to clean and do not function well. Known kitchen tools that have more than one function rarely work well and often malfunction during use, resulting in spills, accidents and wasted foods. Applicant's unitary invention is less likely to malfunction, is very easy to clean and is relatively easy and inexpensive to manufacture. Accordingly, the device will have substantial consumer appeal.

### SUMMARY OF THE INVENTION

The inventive kitchen utensil disclosed herein is a unitary device having multiple functions. More particularly, it is a bowl manufactured of heat resistant materials which are dishwasher safe and microwave safe. It is preferably a shallow bowl having a substantially flat bottom with a congruent and continuous side that is integral with the bottom so that there is not a substantial seam between the side and bottom. For ease of reference, the bowl has a first end, a spaced apart second end, a pair of opposed sides and the side has an upper periphery.

The bowl is preferably elongated and substantially rectangular in shape. At the first end of the bowl a strainer or colander is formed at the top periphery of the bowl side. The colander is substantially planar, spans the width of the bowl and is integral with the top of the opposing sides and the first end. Further, the colander has a plurality of holes through which liquids in the bowl can be drained when the bowl is tilted toward the first end. The span of the colander across the top of the bowl prevents solids from falling out of the bowl as it is tilted. The colander can be made with a variety of geometric shapes without departing from the scope of the invention. In one embodiment of the invention, a plurality of drain holes are also formed in the side wall of the first end which facilitates better draining of liquids from the device without tipping it to a degree where food can spill. The colander is large enough to capture substantially all of the food which would normally be contained within the bowl as it is tilted toward the first end for draining.

Formed integrally with the second end of the bowl is a funnel assembly. Similar to the colander at the first end, the funnel assembly spans the width of the second end and is integral with the top of the opposing sides and end. The funnel itself includes an opening through the end wall preferably at the center of the second end. The funnel may include a spout exterior the second end wall. In one embodiment, a plurality of drain holes replaces the opening at the spout. The drain holes facilitate simultaneous draining and pouring of liquid from the bowl. For example, the funnel assembly can be used to drain fat laden foods, such as ground meat, into a collection and disposal vessel so the fat is not deposited into kitchen drain pipes. Draining and rinsing fat laden foods can remove undesirable fat from the user's diet. The inventive funnel and drain assembly make this draining process simple, clean and efficient.

Measuring gradient markings may be formed into the wall of the bowl, or applied thereto by known marking methods. Accordingly, the bowl can also be used as a measuring vessel. In one embodiment the markings on one side of the bowl may be liquid gradients while markings on the second side are gradients for dry foods. In another embodiment, the measuring markings on the bowl may indicate serving sizes. The measurement marks are also useful when the bowl is used as a mixing bowl.

Midway between the first and second end and formed near the top of the side is a pouring spout. A spout may be formed in each side of the bowl.

The bottom of the bowl is manufactured of rigid plastic, preferably a solid, non-porous, high density polyethylene material such as that commonly found in “plastic” cutting boards. The bowl bottom is planar and can be used as a cutting board. The dimensions of the bowl are such that a user can easily chop and cut food items on the bowl bottom. Moreover, the bowl can be inverted and the bottom used as a chopping or cutting board.

This versatile and inventive bowl makes it easy to prepare a simple meal. For example, ingredients such as vegetables can be chopped using the cutting board bottom of the bowl. Liquid can be added to the bowl in the desired amount using the helpful measurement markings. The food can be cooked in a microwave oven. Liquid can be drained from the bowl using the colander end or if the liquid is to be saved, it can be poured out of the funnel end. The user can also use the bowl for serving or may eat directly from the bowl. The bowl also is highly functional for washing food items and then draining the liquid from the bowl.

Because the inventive bowl is multi-functional, it may be used for several different functions during meal preparation which also cuts down on clean up time and dish washing.

These and other objects, features and advantages of the present invention should become apparent from the following description and drawings.

### BRIEF DESCRIPTION OF THE DRAWINGS

FIG. 1 is a perspective view of the inventive kitchen utensil.

FIG. 2 is a top plan view of the inventive kitchen utensil.

FIG. 3 is a bottom plan view thereof.

FIG. 4 is a side plan view of the inventive kitchen utensil.

FIG. 5 is an end view of the first end of the inventive kitchen utensil.

FIG. 6 is an end view of the second end thereof.

### DETAILED DESCRIPTION OF THE INVENTION

The following description of the invention is not intended to limit the scope of the claims herein presented. The teaching of the present invention includes the discovery that a variety of shapes, sizes and configurations of the inventive kitchen utensil can be achieved within the scope of this invention as more particularly described herein.

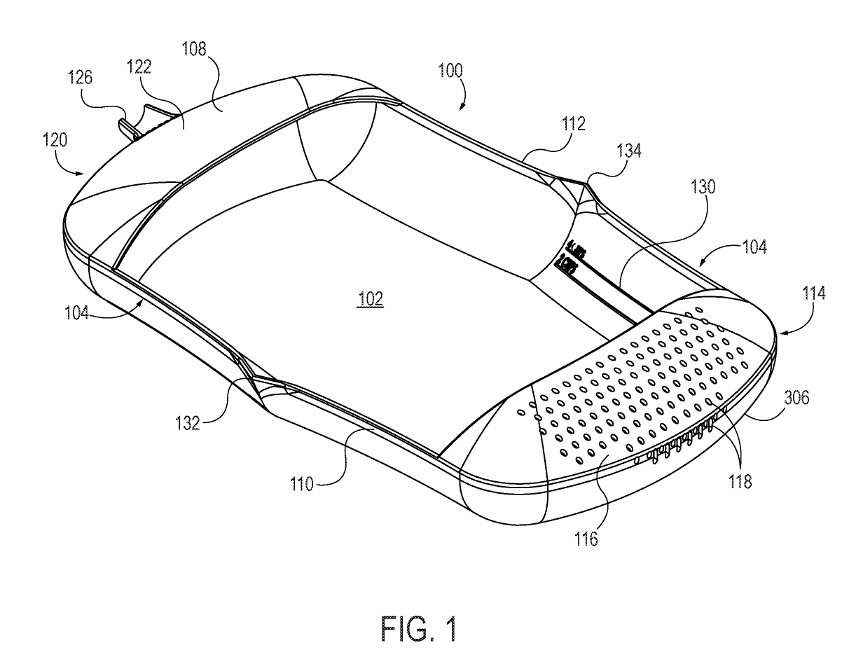

Referring now generally to the drawings, the inventive kitchen utensil disclosed herein is a bowl 100 manufactured of heat resistant materials which are dishwasher safe and microwave safe. As shown in FIG. 1, the bowl 100 is relatively shallow and in its preferred configuration has a substantially flat bottom 102 with a congruent and continuous side wall 104, having a top periphery 105, where the wall 104 is integrally formed with the bottom 102 so that there is not a substantial seam between the side wall 104 and bottom 102. The bowl 100 has a first end 106 and a spaced apart second end 108 and a pair of opposed sides 110, 112.

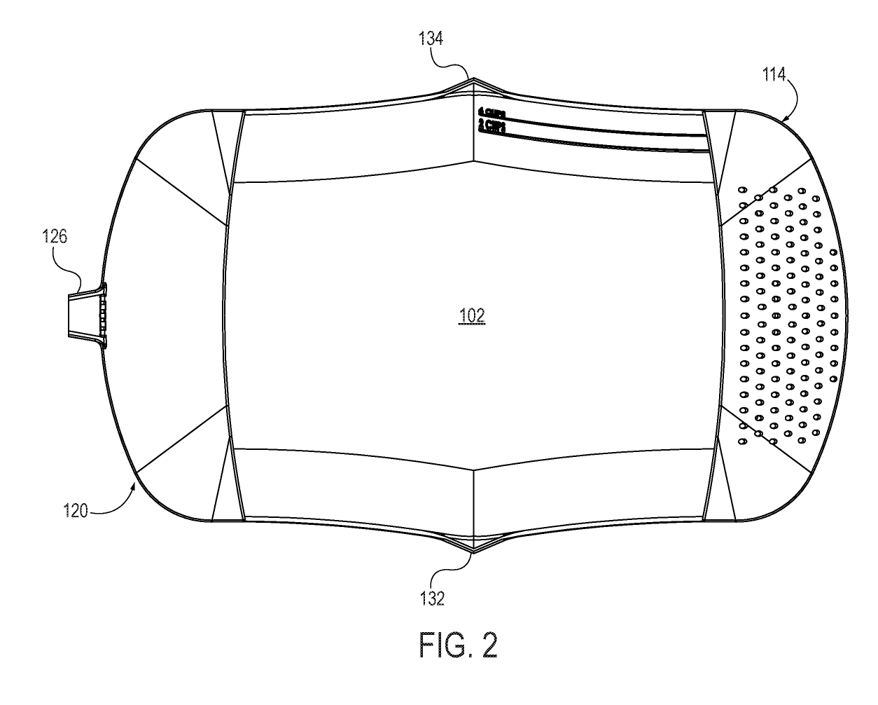

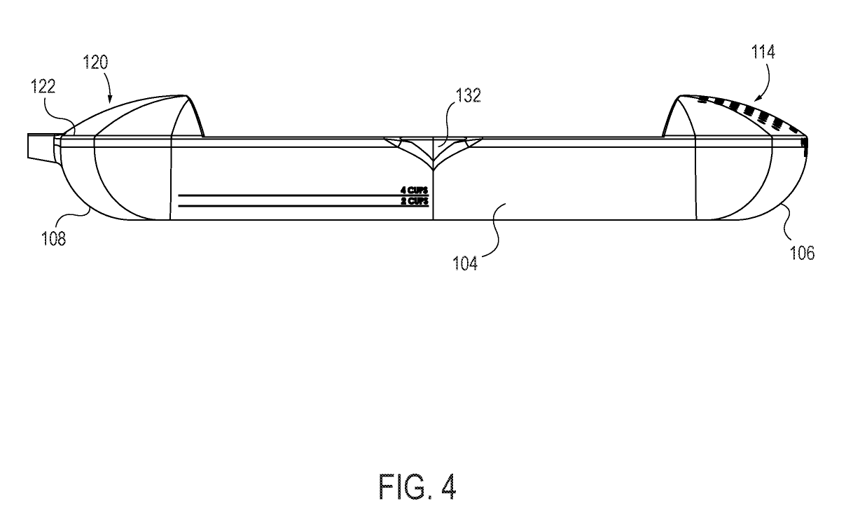

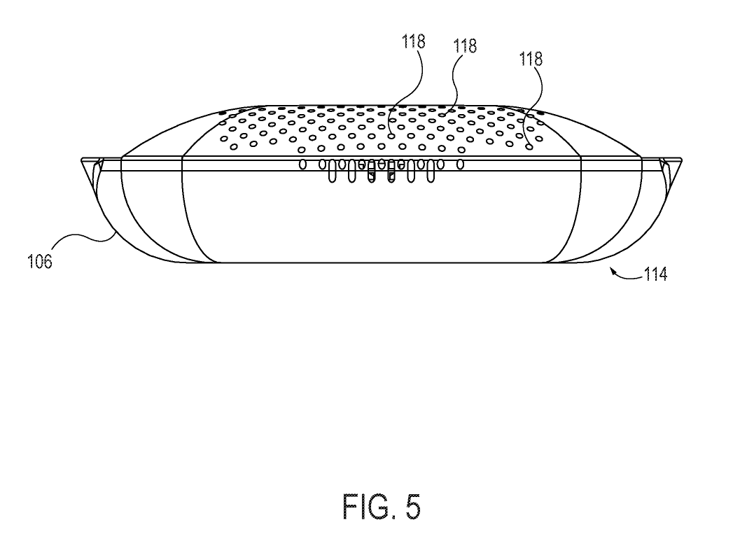

The bowl 100 is preferably elongated and substantially rectangular in shape as best shown in FIGS. 2 and 4. At the first end 106 of the bowl 100 a strainer or colander assembly 114 is formed at the top periphery 105 of the bowl side wall 104. The colander assembly 114 is substantially planar, spans the width of the first end 106 and is integrally formed with the top periphery of the opposing sides 110, 112 at the first end 106. Further, the colander has a plurality of drain holes 118 through which liquids in the bowl can be drained when the bowl is tilted toward the first end 106. In the preferred embodiment, as best shown in FIG. 5, drain holes 118 are also provided near the top periphery 105 of the side wall 104 at the first end 106, adjacent the drain holes 118 provided in the colander 116. The span of the colander assembly 114 across the top of the first end 106 of the bowl 100 prevents solids from falling out of the bowl 100 as it is tilted. The colander 116 can be formed with a variety of geometric shapes without departing from the scope of the invention.

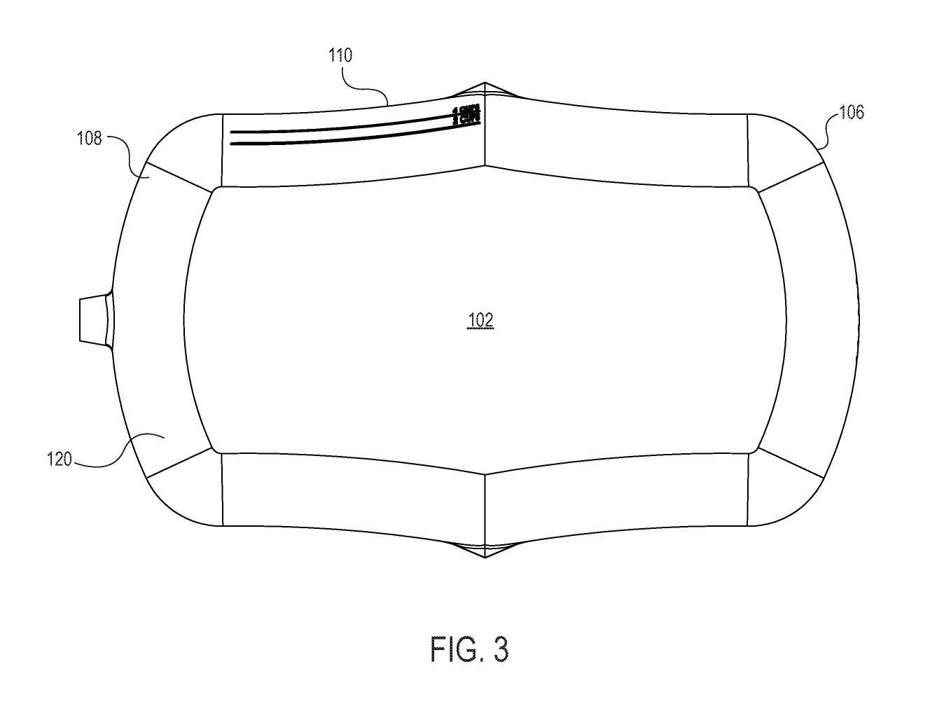

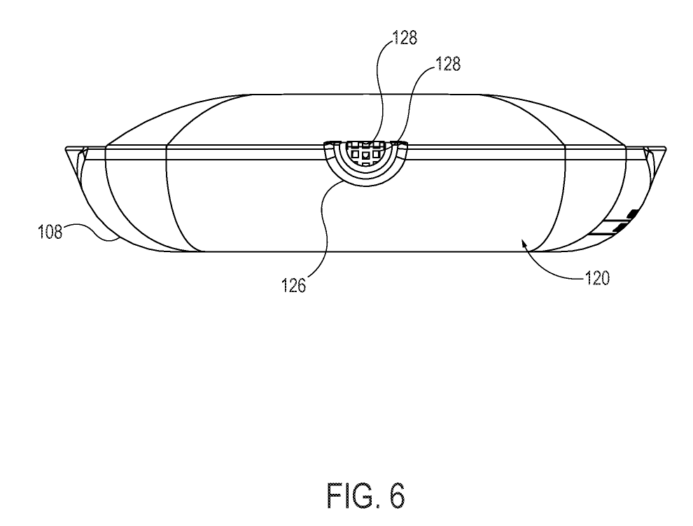

As best shown in FIGS. 1, 3 and 6, a funnel assembly 120 is formed integrally into the second end 108 of the bowl 100. Similar to the colander assembly 114 at the first end 106, the funnel assembly 120 spans the width of the second end 108 and is integrally formed with the top periphery 105 of the opposing sides 110, 112 and the second end 108. The funnel 122 includes an opening 124 through the second end wall 102 preferably at the center of the second end 108 near the upper periphery 105. The funnel 122 may include a spout 126 exterior the side wall 104. In one embodiment, a plurality of drain holes 128 replaces the opening 124 at the spout 126. The drain holes 128 facilitate simultaneous draining and pouring of liquid from the bowl 100.

Shown in FIG. 1, measuring gradient markings 130 may be formed into the side wall 104 of the bowl 100, or applied thereto by known marking methods. Accordingly, the bowl 100 can also be used as a measuring vessel. A variety of markings may be used, including liquid volume, dry goods volume, serving sizes and the like. These measurement marks 130 are also useful when the bowl 100 is used as a mixing bowl.

Approximately halfway between the first end 106 and second end 108 and formed near the upper periphery 105 of the first side 110 is a first pouring spout 132. A second pouring spout 134 may be formed in each upper periphery 105 of the second side 112 opposite the first pouring spout 132. These spouts are useful for pouring out the contents of the bowl without straining through the colander or funnel.

The bottom 102 of the bowl is manufactured of rigid plastic, preferably a solid, non-porous, high density polyethylene material such as that commonly found in “plastic” cutting boards. The bottom 102 is planar and can be used as a cutting board. Because the bottom 102 is flat it fully contacts a work surface during use to limit movement during use. The dimensions of the bowl are such that a user can easily chop and cut food items on the bowl bottom 102. Moreover, the bowl can be inverted and the bottom 102 used as a chopping or cutting board.

It is to be understood that the bowl can be made in a variety of shapes and sizes. The colander 116 can have any number of drain holes 118 at, on or near the colander assembly 114 or the side wall 104 of the first end 106. The funnel assembly 120 can be made with an opening 124 or drain holes 128. The spout 126 can be any size and can be a fully enclosed or partially open spout. A lid (not shown) can be provided so the bowl 100 can be used for food storage.

The foregoing description has been directed to particular embodiments of the invention for illustrative purposes and explanation of the inventive device. It will be apparent to those skilled in this art that modifications and changes may be made without departing from the scope and spirit of the invention. The following claims are intended to encompass all such modifications.

What is claimed is:

1. A multi-function kitchen utensil, comprising:
a bowl having a bottom and a contiguous side wall, a first end and a spaced apart second end and a pair of opposed sides;
a colander assembly formed at the first end of the bowl, the colander assembly spanning between the opposed sides and integrally formed with the side wall, wherein the colander assembly is provided with a plurality of drain holes;
a funnel assembly formed at the second end of the bowl, the funnel assembly spanning between the opposed sides and integrally formed with the side wall, wherein the funnel assembly includes an opening through the side wall and a spout formed adjacent the opening; and
wherein the bottom of the bowl comprises a cutting board.

2. The multi-function kitchen utensil of claim 1 further comprising at least one pouring spout formed in the side wall.

3. The multi-function kitchen utensil of claim 1 further comprising measuring gradient markings formed in the side wall.

4. The multi-function kitchen utensil of claim 1, wherein the opening of the funnel assembly comprises a plurality of drain holes.

5. The multi-function kitchen utensil of claim 1 further comprising a plurality of drain holes formed through the side wall at the first end below colander.

6. A multi-function kitchen utensil, comprising: a bowl having a bottom, a contiguous side wall, a first end, a second end and a pair of opposed sides; a colander assembly formed at the first end of the bowl; a funnel assembly formed at the second end of the bowl; and wherein the bottom comprises a cutting board.

7. A multi-function kitchen utensil, comprising:
a bowl having a bottom and a contiguous side wall, a first end and a spaced apart second end and a pair of opposed sides;
a funnel assembly formed at the second end of the bowl, the funnel assembly spanning between the opposed sides and integrally formed with the side wall, wherein the funnel assembly includes an opening through the side wall and a spout formed adjacent the opening; and
wherein the bottom of the bowl comprises a cutting board.

8. The multi-function kitchen utensil of claim 7, further comprising a colander assembly formed at the first end of the bowl, the colander assembly spanning between the opposed sides and integrally formed with the side wall, wherein the colander assembly is provided with a plurality of drain holes.
